(19) United States
(12) Patent Application Publication
(10) Pub. No.: US 2026/0293876 A1
(43) Pub. Date: Oct. 1, 2026

(54) Sticky Pantonne Blue Fly Trap

(71) Applicant: Florida Insect Control Group LLC, Gainesville, FL (US)

(72) Inventors: Philip G. Koehler, Gainesville, FL (US); Enrico Paolo Levi, Modena (IT)

(21) Appl. No.: 19/702,510

(22) Filed: Jun. 9, 2026

Related U.S. Application Data
(63) Continuation-in-part of application No. 19/279,689, filed on Jul. 24, 2025.
Application No. 19/279,689 is a continuation-in-part of application No. 18/650,815, filed on Apr. 30, 2024, now abandoned.
(60) Provisional application No. 63/463,456, filed on May 2, 2023.

(51) Int. Cl. A01M 1/14; A01M 1/16

(52) U.S. Cl. CPC A01M 1/145; A01M 1/16

(57) ABSTRACT

Systems, devices, and methods for inexpensive multi-sheet fly traps. Each sheet selected from plastic, paper, cardboard, card-stock, with black line patterns over or under one Pantone 115-5C blue color. The blue consists of dye mixtures that reflect wavelengths between approximately 460 to approximately 490 nm. The patterns emulate cracks, surface edges sized to attract flies having feathers, rectangle cracks, parallelogram cracks, curve/crescent cracks, and other geometrical cracks. The blue color is a manufactured base layer with transparent glue layer. Alternatively, the blue color is formed from a blue glue surface-layer on a base. A peel and stick layer is over the glue surface. Traps have no toxicants, safe to handle, and don't require government approval. No other colors used. Each sheet has Pantone 115-5C on either or both the front and rear sides. A peel and stick cover layer is over either or both the front side and rear sides.

### CROSS-REFERENCE TO RELATED APPLICATIONS

This application is a Continuation-in-Part of U.S. patent application Ser. No. 19/279,689 filed Jul. 24, 2025, which is a Continuation in Part of U.S. patent application Ser. No. 18/650,815 filed Apr. 30, 2024. abandoned, which claims the benefit of priority to U.S. Provisional Application Ser. No. 63/463,456 filed May 2, 2023. the entire disclosure of each of these applications listed in this paragraph are incorporated herein by specific reference thereto.

### FIELD OF INVENTION

This invention relates to fly traps, and in particular to systems, devices, and methods for providing a calendar configuration for a multi-sheet fly trap, with each sheet having a sticky exposed surface of a Pantone 115-5C blue color on a plastic or paper sheet, which is exposed when the covering sheet is removed, and each sheet having patterns of spaced apart black lines over a blue surface, which the black lines sized to emulate cracks or surface edges to attract the flies thereon, and the sticky sheets can be left up for a period of time from a day to a month, to a year, and then be ripped off and discarded.

### BACKGROUND AND PRIOR ART

Sticky fly paper has been available for over a century. See for example, U.S. Pat. No. 417,400 to Thum, which was granted in 1889. However, these traditional sticky fly papers are restricted primarily to a single sheet/board having a sticky surface that when exposed causes flies that are on the sticky surface to become trapped.

Traditional sticky fly paper uses a uniform-colored surface as the sticky surface, which generally only works when the flies land on the sticky surface or fly close to the sticky surface. Additionally, the prior art is limited to a one time use for the sticky paper, and not to plural stackable sticky fly paper applications.

One of the subject inventors developed a “Fly Attractant System with Toxicant Treated Cords” in U.S. Pat. No. 9,089,121 to Diclaro, II et al., which is incorporated by reference. However, this device used black cords that were treated with toxicants over a blue colored background, and was NOT used to trap live insects. Instead, this device used the toxicant treated cords to kill the insects with insecticidal bait.

Toxicants, are dangerous and unsafe to anyone that handles the live fly trapping device. The use of Toxicants further requires further approval from government agencies, such as the Environmental Protection Agency to be marketed in the United States. This approval, called pesticide registration, takes years to get approval, and involves listing of the manufacturing locations.

Double-Sided Sticky Insect Traps AM Leonard 2020 and an actual product sold by the Leonard reference uses 9″ by 5″ cards that requires a sticky layer on BOTH sides of their cards with black lines. One side requires a dark blue color with black lines and sticky surface, and the opposite side requires a yellow color with black lines and sticky surface. The subject inventors have discovered that yellow surfaces do NOT attract sufficient flies to be effective. And the black lines in Leonard in contrast with the dark blue color were NOT wide enough to substantially attract flies. The actual Leonard product sells for over $50 and has been listed on the web for $59.53, which is extremely expensive.

The subject invention is expected to sell for up to approximately $10, which is less than one fifth the retail price of the $59.33 price for the Leonard Double-sided Insect traps.

The thin black lines less than 1 mm wide) in Leonard are NOT wide enough for a fly to think they are cracks where they can hide to avoid desiccation. So, the lines are not practical to attract insects at all. In fact, the purpose of the thin black lines is to provide a grid so captured insects can easily be counted for monitoring purposes. The black lines in Leonard are too thin to attract flies thereto.

As referenced in the subject detailed description, the Leonard product with blue surface was directly tested against the subject invention Pantone 115-5C blue color, on Dec. 22, 2025 in two tests.

For both test #1 and #2, the number of flies captured on the Pantone P 115-5C colored card far exceeded the number of flies captured on the Leonard dark blue card. In test #1 the Pantone card caught 3 times more flies and in test #2 the Pantone card caught 9 times more flies than the Leonard dark blue card.

China Patent CN 108669032 to Liu is described as a “luminous insect sticking device” covers a “blue insect sticking board and yellow sticky trap. The “blue sticky surface coating mixed with the sticker of blue afterglow material. Similar to Leonard, the combination of two different color sticking boards does not work to effectively trap live flies. Liu requires “the pest sticking glue is added with blue long afterglow material.

The blue afterglow Liu product is NOT the same shade of Pantone 115-5C of the subject invention. Liu requires a “special” light for the afterglow effect. That “special” light would be ultraviolet light that causes the dye to fluoresce in a different wavelength of light than the subject invention requirement for using Pantone 115-5C blue.

The fluorescent color in Liu only would be seen after dark and flies do not fly in the dark.

S. Wang, R. Liu, J. Li, C. Meng, J. Liu, J. Chen, P. Cheng, K. Wu, Angew. Chem. Int. Ed. 2024, 63, e202403927. https://doi.org/10.1002/anie.202403927 and specifically states that the “after glow” is at 375, 475, AND 730 nm. Those are not wavelengths for Pantone 115-5C. There is no way that flies would be attracted to Blue long afterglow.

Additionally, there is no evidence that Blue long afterglow is at all similar to Pantone 115-5C in attractance to flies, especially since the afterglow part of the dye is seen in the dark when flies do not fly.

Pantone 115-5C is a mixture of dyes that reflect wavelengths of 460-490 nm that results in a sky-blue color.

Blue long afterglow is a combination of color mixtures of 375, 475, and 730 nm. The 375 nm is in the ultraviolet wavelength, 475 is blue-green, and 730 is far-red.

There is no similarity of color between Pantone 115-5C and Blue long afterglow based on the visual analysis of the colors. Additionally, there is no evidence that Blue long afterglow is at all similar to Pantone 115-5C in attractance to flies, especially since the afterglow part of the dye is seen in the dark when flies do not fly.

Similar to Leonard, Liu also requires the double color traps of yellow and blue. As discussed, the dark blue shade in Leonard and the “afterglow part of the dye” used in Liu would NOT attract significant numbers of flies.

Further neither Leonard nor Liu describe, teach nor suggest having a sticky trap with blue sticky surfaces on both sides of the sticky trap card/sheet as also shown in the subject patent application.

U.S. Pat. No. 4,738,049 to Baley, which is incorporated by reference, describes a Fly Trap, title, can use the color “blue” in a lower trap. Baley is a baited mailaise type trap where flies enter the trap and cannot find a way out. It is composed of a pyramid-like structure surrounded by a plastic casing with entry areas for flies. The base can be composed of an undefined blue, yellow, or black color. This trap has no commonality with our invention. Baley attracts flies to a bait that are placed in the trap. The color of the trap has no relevance to its attractiveness.

U.S. Pat. No. 9,015,988 to Zhang et al., which is incorporated by reference, describes using blocks of colors that can include wavelengths of 450-495 nm. However, the blocks are limited to shapes of insects, and are not across an entire face of a fly trap. Zhang states that the “blocks (are) within . . . size of the target insect”, abstract. Zhang is for attracting wasps and flies to a clustered pattern of small blocks on a white background. Each block is colored blue that reflect light in 450-495 nm or 520-565 nm wavelengths. That configuration is completely different from the solid background in our invention is Pantone 115-5C blue color. Pantone is a standardized color system of 2161 colors. Our color is one of thousands. Also, our invention does not include blocks (small squares) it utilizes lines that flies perceive as a crack or crevice to squeeze into for harborage. The small target block sizes of a fly and wasp does NOT cover a blue color across an entire face of a sheet as done in the subject invention. Further, the Zhang structures are restricted to elongated pillar or stick shapes, shown in hexagon faces, on a bulky type frame that is not similar to multiple sheets as in the subject invention. The bulky Zhang devices would substantially and unsightly protrude away from a wall or table top surface The subject invention multiple sheet fly trap device would appear substantially flush against a wall or table top surface during use, and not be unsightly in appearance during use. The bulky Zhang devices are not easily disposable. Our invention is entirely different in appearance, structure and function, and the sheets are easily disposable.

U.S. Published Patent Application 2024/0334921 to Furner et al., which is incorporated by reference, describes, and shows an INSECT FLY TRAP, title, that can use Pantone blue colors. However, the fly trap requires a plug in electric power supply and uses LEDs (light emitting diodes), and is of such a small size would not be suitable for the fly trap sizes needed to trap flies. Furner is an attractant system that is a light trap. The light trap utilizes blue and UV LEDs as well as a blue background to attract flying insects to a sticky surface. Our invention does not utilize artificial light as an attractant. Also, the glue is not applied to the blue colored surface in the Furner trap, it is applied to a separate part.

### SUMMARY OF THE INVENTION

A primary objective of the present invention is to provide a calendar configuration for a multi-sheet fly trap, with each sheet having a sticky exposed surface on a plastic or paper sheet, which is exposed when the covering sheet is removed, and each sheet having patterns of spaced apart black lines with a Pantone 115-5C blue color surface, with the black lines sized to emulate cracks or surface edges to attract the flies thereon, and the sticky sheets can be left up for a period of time from a day to a month, and then be ripped off and discarded.

A secondary objective of the present invention is to provide the Pantone 115-5C blue color surface, as a separate blue glue layer that maintains a sticky state when exposed.

A third objective of the present invention is to provide a clear transparent glue layer over a sheet manufactured with a Pantone 115-5C blue color surface, having patterns of lack lines thereon, where the clear transparent glue layer maintains a sticky state when exposed that maintains a sticky state when exposed.

A fourth objective of the present invention is to provide a sticky fly trap limited to having one color of Pantone 115-5C blue color, and no other colors.

A fifth objective of the present invention is to provide a sticky fly trap sheet having one side with color of Pantone 115-5C blue color, and no other colors.

A sixth objective of the present invention is to provide a sticky fly trap sheet having both sides having a color of Pantone 115-5C blue color, and no other colors.

A seventh objective of the present invention is to provide a sticky fly trap that does not use nor require any toxicants, which are dangerous and unsafe to anyone that handles the live fly trapping device.

An eighth objective of the present invention is to provide a sticky fly trap that does not require approval from government agencies, such as the Environmental Protection Agency to be marketed in the United States. This approval, called pesticide registration, takes years to get approval, and involves listing of the manufacturing locations.

A preferred embodiment includes grids of black lines over a blue colored background on each sheet, having a sticky surface. And a peelable layer over each sticky surface. The preferred embodiment uses Pantone 115-5C is a mixture of dyes that reflect wavelengths of approximately 460 to approximately 490 nm that results in a sky-blue color.

Another fly trap device embodiment includes a plurality of single sheets stacked together having a rectangular shape configuration each sheet selected from the group consisting of a cardboard sheet, card stock, a paper sheet, and a plastic sheet, each of the single sheets having a front side and a rear side, at least one side of each of the single sheets consisting of black line patterns on a black grid over a noncolor background, the black line patterns include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes; at least one layer of blue glue, the at least one layer of the blue glue overlaying the at least one side of each sheet forming a blue sticky surface, and the black line patterns are visible through the layer of blue glue, wherein each sheet with the blue sticky surface and black line pattern is exposed for a selected period of time, and then discarded, wherein the layer of blue glue is formed from glue consisting of a mixture of dyes that reflect wavelengths of approximately 460 to approximately 490 nm that results in a sky-blue color, the layer of blue glue is selected from the group consisting of blue liquid glue, blue glue from a blue stick of glue, glue with blue glitter, and non-drying photo mount glue, wherein the blue glue maintains a sticky state after being applied; and at least one peel and stick cover sheet, the at least one peel and stick cover sheet overlaying the at least one side of each sheet, wherein removing the peel and stick cover sheet exposes the blue sticky surface, wherein each sheet with the sticky surface and black line pattern is exposed for a selected period of time, and then discarded.

The fly trap device includes both the front side and the rear side consists of the black line patterns on the grid, and the at least one layer of the blue glue, and the at least one peel and stick cover sheet.

The mixture of dyes consists of dyes having the color of Pantone 115-5C blue color.

Another fly trap device for trapping live flies without toxicants, for use during day time hours between sunrise and sunset, consists of a plurality of single sheets stacked together having a rectangular shape configuration each sheet selected from the group consisting of a cardboard sheet, card stock, a paper sheet, and a plastic sheet; each of the single sheets having a front side and a rear side; at least one side of each of the single sheets solely consisting of a layer of blue consisting of a mixture of dyes that reflect wavelengths of approximately 460 to approximately 490 nm that results in a sky-blue color; black line patterns which include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes; a layer of transparent glue overlaying the at least one side of each sheet forming a sticky surface, wherein the black line patterns and the blue layer are visible, wherein each sheet with the sticky surface and black line pattern is exposed for a selected period of time, and then discarded; and

at least one peel and stick cover sheet overlaying the at least one side of each sheet, wherein removing the peel and stick cover sheet exposes the blue sticky surface, wherein each sheet with the sticky surface and black line pattern is exposed for a selected period of time, and then discarded.

The fly trap device can include both the front side and the rear side consists of the black line patterns, the blue layer, the transparent glue layer, and the at least one peel and stick cover sheet.

The mixture of dyes consists of dyes having the color of Pantone 115-5C blue color.

Another rectangular shaped fly trap device for trapping live flies without toxicants limited to using one color of Pantone 115-5C blue color, and no other colors, for use during day time hours between sunrise and sunset, consists of a plurality of single sheets stacked together having a rectangular shape configuration, each sheet selected from the group consisting of a cardboard sheet, card stock, a paper sheet, and a plastic sheet; each of the single sheets solely consisting of black line patterns on a black grid over a noncolor background, the black line patterns include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes; and a layer of blue glue overlaying each sheet forming a blue sticky surface on each sheet, and the black line patterns are visible through the layer of blue glue, wherein each sheet with the sticky surface and black line pattern is exposed for a selected period of time, and then discarded, wherein the layer of blue glue is formed from glue consisting of a mixture of dyes that reflect wavelengths of approximately 460 to approximately 490 nm that results in a sky-blue color, the layer of blue glue is selected from the group consisting of blue liquid glue, blue glue from a blue stick of glue, glue with blue glitter, and non-drying photo mount glue, wherein the blue glue maintains a sticky state after being applied; a peel and stick cover sheet overlaying the front side of each sheet, wherein removing the peel and stick cover sheet exposes the blue sticky surface, wherein each sheet with the sticky surface and black line pattern is exposed for a selected period of time, and then discarded, wherein the fly trap device is limited to using only one color.

The mixture of dyes consists of dyes having the color of Pantone 115-5C blue color.

A rectangular shaped fly trap device for trapping live flies without toxicants limited to using one color of Pantone 115-5C blue color, and no other colors, for use during day time hours between sunrise and sunset, consists of a plurality of single sheets stacked together having a rectangular shape configuration each sheet selected from the group consisting of a cardboard sheet, card stock, a paper sheet, and a plastic sheet; each of the single sheets solely consisting of a layer of blue consisting of a mixture of dyes that reflect wavelengths of approximately 460 to approximately 490 nm that results in a sky-blue color; black line patterns on a black grid, the black line patterns include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes; a layer of transparent glue overlaying each sheet forming a sticky surface on the front side of each sheet, wherein the black line patterns and the blue layer are visible, wherein each sheet with the sticky surface and black line pattern is exposed for a selected period of time, and then discarded; and a peel and stick cover sheet overlaying each sheet, wherein removing the peel and stick cover sheet exposes the blue sticky surface, wherein each sheet with the sticky surface and black line pattern is exposed for a selected period of time, and then discarded, wherein the fly trap device is limited to using only one color.

The mixture of dyes consists of dyes having the color of Pantone 115-5C blue color.

Another embodiment includes grids of black lines over a pantone 115-5C blue color with sticky surface on both sides of sheet. Peel and stick cover sheets can be initially applied to both the front and rear sides of each sheet. One peel and sheet cover can be removed to expose the sticky surface for use to trap flies. When the exposed side traps collect a sufficient of flies, the peel and stick cover on the opposite side can be removed, and used to cover over the original sticky exposed surface having captured flies, so that the opposite side with sticky surface can be used to trap flies.

Further objects and advantages of this invention will be apparent from the following detailed description of the presently preferred embodiments which are illustrated schematically in the accompanying drawings.

### BRIEF DESCRIPTION OF THE FIGURES

The drawing figures depict one or more implementations in accord with the present concepts, by way of example only, not by way of limitations. In the figures, like reference numerals refer to the same or similar elements.

FIG. 1 is a first embodiment showing a grid pattern for a single sticky surface sheet for a calendar shaped configuration for the blue sticky fly glue board with black lines.

FIG. 2 is a second embodiment showing a plural parallel vertical spaced apart line pattern for a single sticky surface sheet for a calendar shaped configuration for the blue sticky fly glue board with black lines.

FIG. 3 is a third embodiment showing a plural horizontal spaced apart line pattern for a single sticky surface sheet for a calendar shaped configuration for the blue sticky fly glue board with black lines.

FIG. 4 is a bar graph of the results of a 2021 Fly Capture Experiments.

FIG. 5A shows an image of black line pattern over blue background used in the 2021 Capture Experiments.

FIG. 5B shows an image of black line pattern over a yellow background used in the 2021 Capture Experiments.

FIG. 6 is a bar graph of the results of a 2022 Fly Capture Experiments.

FIG. 7A shows an image of white line pattern over a black background used in the 2022 Capture Experiments.

FIG. 7B shows an image of blue line pattern over a yellow background used in the 2022 Capture Experiments.

FIG. 7C shows an image of black line pattern over a yellow background used in the 2022 Capture Experiments.

FIG. 8 shows a first embodiment of a feathering crack pattern in black over a blue background.

FIG. 9 shows a second embodiment of a feathering crack pattern in black over a blue background.

FIG. 10 shows a third embodiment of a feathering crack pattern in black over blue background.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps.

Additionally, steps may be performed in any suitable order. As used in this document, “each” refers to each member of a set or each member of a subset of a set.

The embodiments describe different versions of a calendar configuration of a plurality of glue boards and/or sticky sheets with different patterns of black lines over a colored background having a sticky surface.

For example, each sheet or board can be formed from paper or plastic with a surface having a solid blue color, printed with black lines. The entire surface of one side, can be covered with a sticky glue surface, so that the one side becomes a sticky fly trap.

Flies are attracted to the color blue with black lines.

Flies approach the blue and either think the black area is a crack or edge of a surface. So, the flies will then land on the blue right next to the black lines

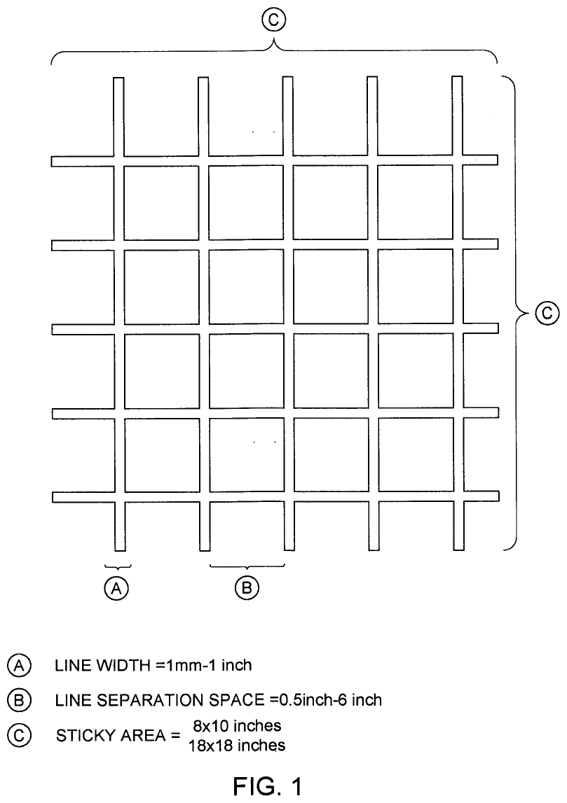

FIG. 1 is a first embodiment showing a black line grid pattern for a single sticky surface sheet for a calendar shaped configuration for the blue sticky fly glue board with black lines.

The grid pattern can include individual black lines A, each having a line width of approximately 1 mm to approximately 1 inch. The separation space B, between the black lines can be between approximately 0.5 inches to approximately 6 inches.

The sticky surface area for each sheet/board can be approximately 8 inches by approximately 10 inches.

Additionally, the sticky surface area C, for each sheet/board can be approximately 18 inches by approximately 18 inches.

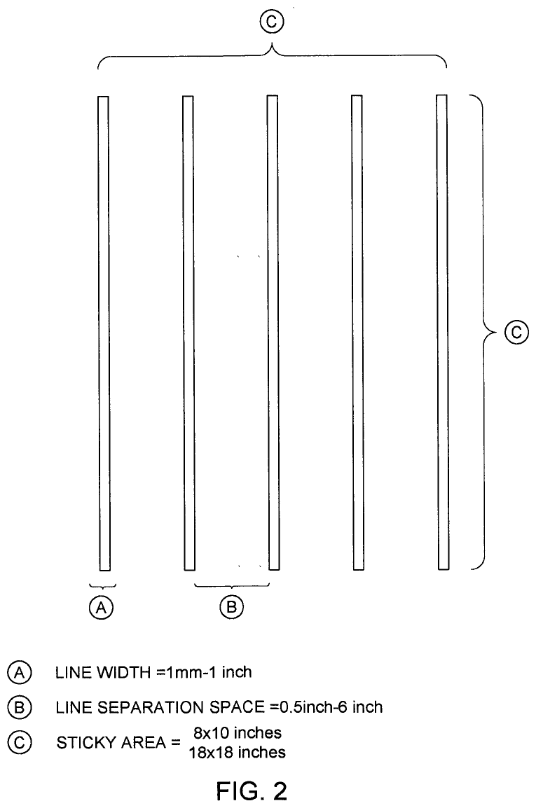

FIG. 2 is a second embodiment showing a plural parallel vertical spaced apart black line pattern for a single sticky surface sheet/board for a calendar shaped configuration for the blue sticky fly glue board with black lines.

Each black line can have a width A, between approximately 1 mm to approximately 1 inch. The separation space B, between the lines can be between approximately 0.5 inches to approximately 1 inch.

The sticky surface area C for each sheet/board can be approximately 8 inches by approximately 10 inches.

Additionally, the sticky surface area for each sheet can be approximately 18 inches by approximately 18 inches.

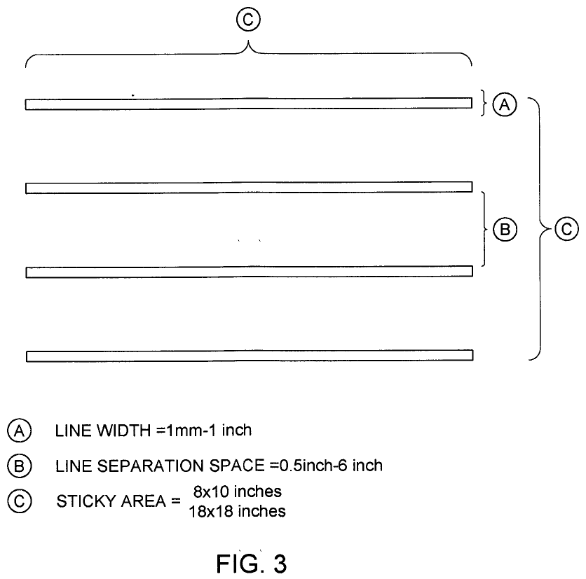

FIG. 3 is a third embodiment showing a plural horizontal spaced apart black line pattern for a single sticky surface sheet/board for a calendar shaped configuration for the blue sticky fly glue board with black lines.

Each black line can have a width A, between approximately 1 mm to approximately 1 inch. The separation space B, between the lines can be between approximately 0.5 inches to approximately 1 inch.

The sticky surface area C for each sheet/board can be approximately 8 inches by approximately 10 inches.

Additionally, the sticky surface area for each sheet can be approximately 18 inches by approximately 18 inches.

The fly catching trap can be in the form of a flip calendar that exposes one sheet/board at a time and is hung on a wall or set on a table/desk.

The calendar images on each page, can be individual dates, and/or individual days of the week, and/or a single week, a single month, a plurality of months, an entire year, and the like.

The calendar images can be black lines and/or black line patterns, with a blue glue background between each of the black lines, or a blue glue background between each of the horizontal and vertical black lines of the black line patterns.

The invention can be inserted into a fly light trap or inserted into a frame to be hung on a wall.

Each sheet/board can be for a selected period of time, such as but not limited to one day, one week, one month, a year, and the like.

Each sticky surface can include a peelable cover sheet, that when removed exposes the sticky surface. The peelable sheet can include, but is not limited to plastic sheath, wax paper, and the like.

Blue Sticky trap experiments were done on Jun. 9, 2021, at a screenhouse at the University of Florida, Gainesville, Florida

About 300 house flies were released into an outdoor large screened house (the screened house contained the flies in an approximately 15 by approximately 10 ft area.

The flies were left to acclimatize to the screened house for approximately 1 hour.

Colored sticky boards were hung on one of the screened walls of the room. Boards were either blue with black lines, yellow with black lines, or Black with white lines.

Boards were left to capture flies in the glue for approximately 2 hours.

Numbers of flies capture in approximately 2 hours were recorded.

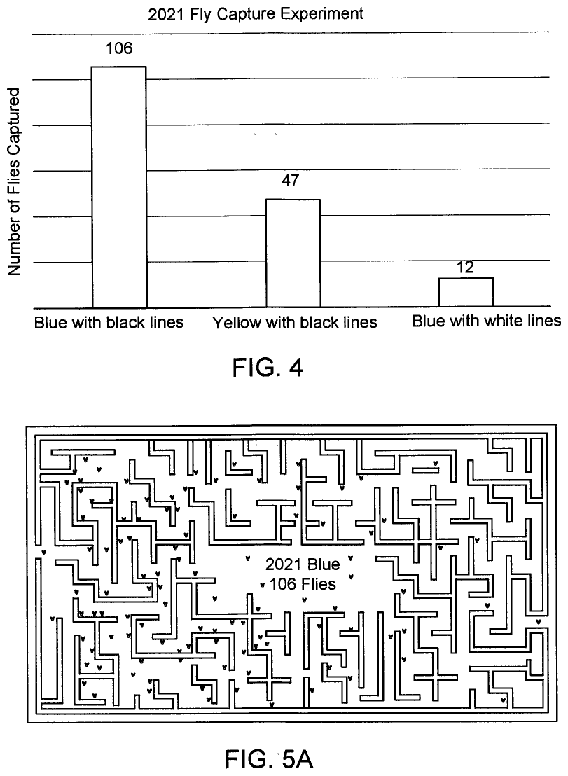

FIG. 4 is a bar graph of the results of a 2021 Fly Capture Experiment.

A total of 106 flies were caught on the blue with black lines board.

A total of 47 flies were caught on the yellow with black lines board, A total of 12 flies were caught on the black with white lines board.

A comparison of Blue with Black lines captured shows that 2.3 times more flies than yellow with black lines, and 8.8 times more flies than Black with white lines.

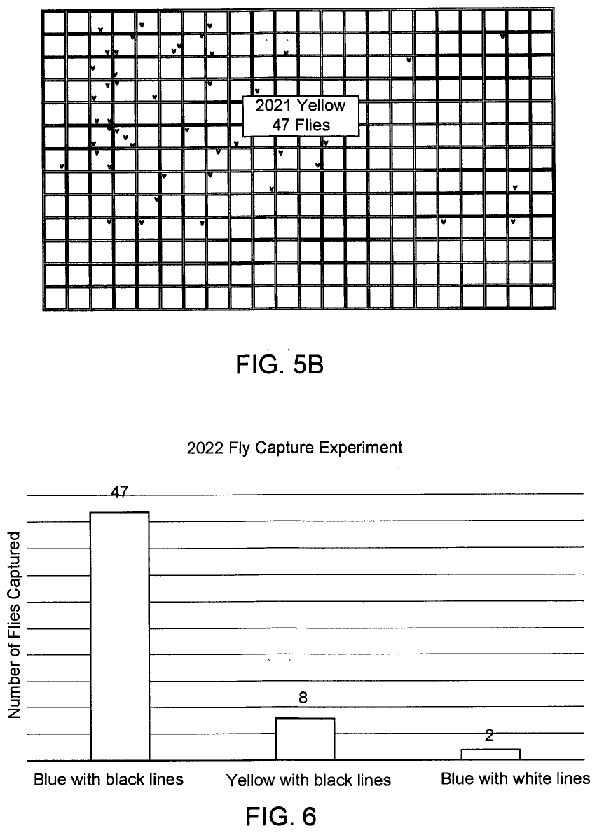

FIG. 5A shows an image of black line pattern over blue background used in the 2021 Capture Experiments.

FIG. 5B shows an image of black line pattern over a yellow background used in the 2021 Capture Experiments.

A 2022 Fly Capture Study on Colored Sticky Boards was done on Sep. 7, 2022, at a screenhouse at the University of Florida, Gainesville, Florida.

About 300 flies were released into an outdoor large screened house (the screened house contained the flies in an approximately 15 by approximately 10 ft area.

The flies were left to acclimatize to the screened house for approximately 1 hour.

Colored sticky boards were hung on one of the screened walls of the room. Boards were either blue with black lines, yellow with black lines, or Black with white lines.

Boards were left to capture flies in the glue for only approximately 30 min, because of a thunderstorm that moved into the area.

Numbers of flies capture in approximately 2 hours were recorded.

A total of 47 flies were caught on the blue background with black lines board.

A total of 8 flies were caught on the yellow background with black lines board,

A total of 2 flies were caught on the black with white lines board.

Comparing Blue with Black lines captured, showed that 5.9 times more flies than yellow with black lines, and 23.5 times more flies than Black with white lines.

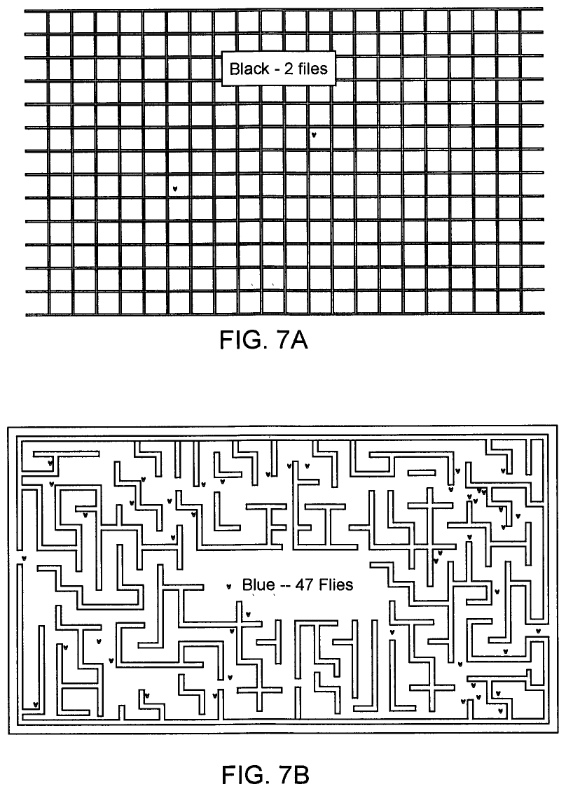

FIG. 6 is a bar graph of the results of a 2022 Fly Capture Experiments.

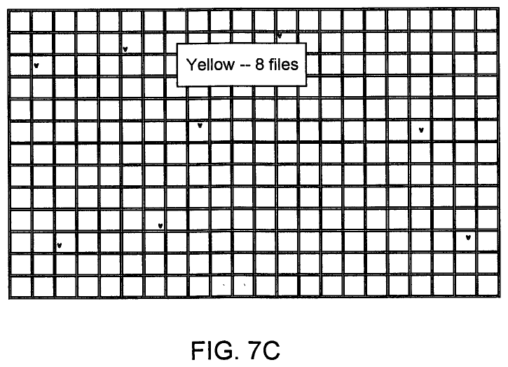

FIG. 7A shows an image of white line pattern over a black background used in the 2022 Capture Experiments.

FIG. 7B shows an image of blue line pattern over a yellow background used in the 2022 Capture Experiments.

FIG. 7C shows an image of black line pattern over a yellow background used in the 2022 Capture Experiments.

From the experiments shown in FIGS. 4-7C, the captured flies landed next to black line patterns over a blue background an average of less than approximately 5 mm from the black line patterns.

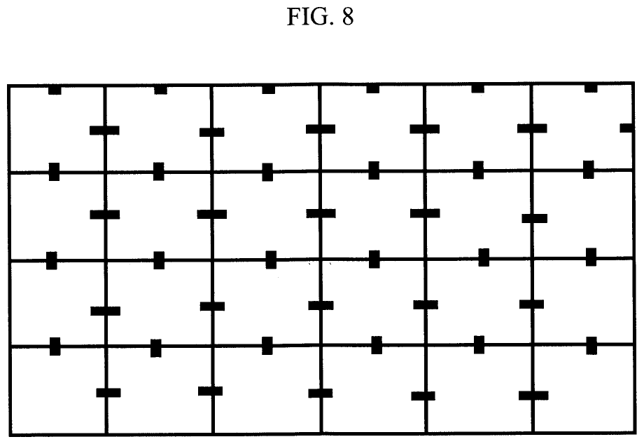

FIG. 8 shows a first embodiment of a feathering crack pattern in black over a blue colored background. This feathering crack pattern covers spaced apart, different size rectangular crack shapes over a grid pattern. The rectangular shape feathers replicate cracks and surface edges which attract the flies to land on. The blue colored background can have a sticky surface, such as previously described, which trap the flies thereon, which attract the flies to land on.

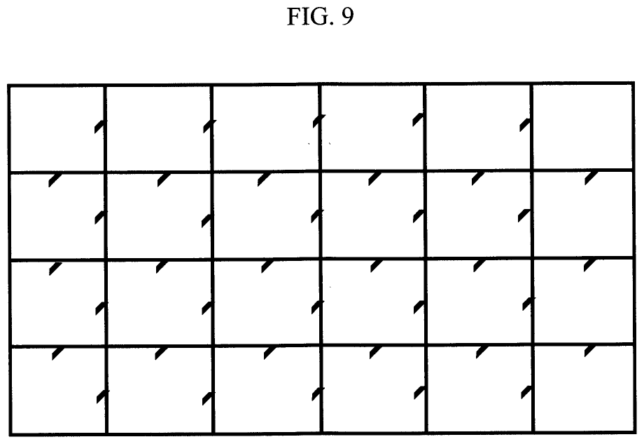

FIG. 9 shows a second embodiment of a feathering crack pattern in black over a blue background. This feathering crack pattern covers spaced apart parallelogram crack shapes over a grid pattern. The parallelogram shape feathers replicate cracks and surface edges. The blue colored background can have a sticky surface, such as previously described, which trap the flies thereon, which attract the flies to land on.

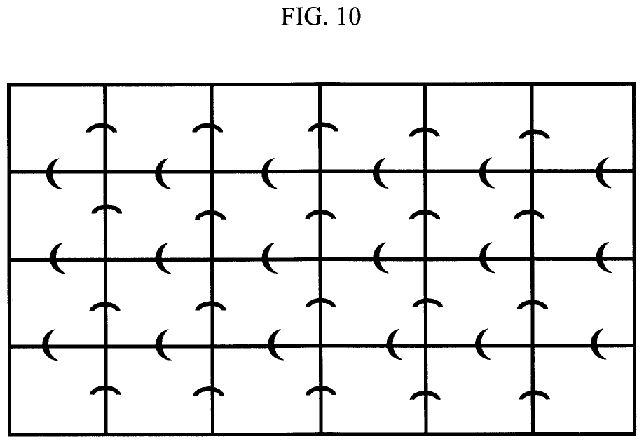

FIG. 10 shows a third embodiment of a feathering crack pattern in black over a blue background. This feathering crack pattern covers spaced apart curve and/or crescent crack shapes over a grid pattern. The curve and/or crescent shape feathers replicate cracks and surface edges. The blue colored background can have a sticky surface, such as previously described, which trap the flies thereon, which attract the flies to land on.

While selected geometric shapes are shown as cracks and surfaces edges to attract flies to land on, other types of geometrical shapes can be used, such as but not limited to circular, semicircular, oval, triangular, cone, pentagon, hexagon, octagon, star, and the like, can be used to replicate cracks and surface edges that attract flies to land thereon.

Referring to FIGS. 8, 9 and 10, the background can be a blue back background with a sticky surface as previously described, wherein the black patterns replicate cracks and surface edges which attract the flies to land thereon.

While an initial blue background with black patterns being applied to the blue background as been previously described, blue backgrounds can be applied as a separate layer.

Blue glue materials, can be applied, such as those used in off-the-shelf products, that can include, but are not limited to ELMERS METALLIC PVA (Polyvinyl Acetate) GLUE, and ELMER'S Glitter Glue Blue which are liquid glues manufactured by Elmer's Products, Inc., Westerville, Ohio. Other types of blue glue that can be used include, but are not limited to UHU magic Blue™ manufactured by UHU GmbH & Co. KG of Baden Germany.

A clear fly sticky glue in a liquid form can be used, such as the Catchmaster Bulk Glue manufactured by AP & G Co., INC. of Brooklyn, New York.

Dyes can be added to the clear sticky glue to achieve a color of Pantone 115-5C blue color. The now sticky blue glue does not dry hard, and can remain in a sticky state after being applied to surface.

These types of blue glue can be in liquid form, and can also be applied in a stick form by rubbing a glue stick against a surface.

Off-the-shelf insect glue that can include a blue pigment added to the glue to achieve a Pantone 115-5C blue color.

Alternatively, a non-drying clear photo mounting glue can used, such as but not limited to 3M Photo Mount Spray Adhesive manufactured by 3M COMPANY of St. Paul, Minnesota. The non-drying photo mounting glue can also be a dyed with dyes to achieve a color of Pantone 115-5C blue color. This non-drying blue colored photo mounting glue can also stay in a sticky state after it is applied to a surface.

Alternatively, the clear pressure-sensitive used by 3M for Post-it® by 3M Company may be used, such as the adhesive shown and described in U.S. Pat. No. 5,194,299 to Fry and U.S. Pat. No. 6,063,329 to Miles et al., which are both incorporated by reference in their entirety. This clear adhesive that remains in a sticky state can also be a dyed with dyes to achieve a color of Pantone 115-5C blue color. This non-drying blue colored photo mounting glue will stay in a sticky state after it is applied to a surface.

The blue glue surface layer can be separately applied to the surface of a base layer such as but not limited to a cardboard sheet layer, paper sheet layer, plastic sheet layer, and the like, where the base layer includes black lines in a pattern thereon, as previously shown and described.

With a glue surface applied to the base with the black line patterns, the black line patterns can bleed through the glue surface. As discussed, the glue surface can remain sticky after it has been applied.

Additionally, a peel and stick layer can be applied over the blue glue surface, where the peel and stick layer can be removed when the product is to be used to attract and trap flies.

The invention can also be practiced with a base layer being white with the black line patterns on the white surface. A blue glue layer can then be overlayed over the black line pattern on a white surface, so that the overall surface is visually blue with back line patterns visible from the blue glue overlayer.

An additional version of the invention can be practiced with a blue sticky surface over a base, and separate black line patterns being separately affixed to the blue sticky surface. The black line patterns can be applied by another layer of black line patterns, with each of the vertical and horizontal black lines separated from one another by the sticky blue glue which remains in a sticky state. Next, a peel and stick layer can overlay both the blue sticky surface and the separately affixed black line patterns.

While various sizes of the calendar trap have been described, the dimension sizes can include other sizes, such as but not limited to approximately 3 inches by approximately 3 inches, approximately 4 inches by approximately 4 inches, approximately 4 inches by approximately 6 inches, approximately 5 inches by approximately 8 inches, approximately 6 inches by approximately 8 inches, approximately 8 inches by approximately 8 inches, approximately 8 inches by approximately 10 inches, approximately 10 inches by approximately 10 inches, approximately 8 inches by approximately 11 and ½ inches, approximately 8.5 inches by approximately 11 inches, approximately 11 inches by approximately 17 inches, and the like. Any minimum size and range of sizes as described above are included.

The calendar trap device can be formed into peel and stick pads similar to Post-it® note pads by 3M Company may be used, and further use the adhesive shown and described in U.S. Pat. No. 5,194,299 to Fry and U.S. Pat. No. 6,063,329 to Miles et al., which are both incorporated by reference in their entirety.

Research Development of Pantone P 115-5C as the Blue Color for The Sticky Fly Trap. The inventors first started out in 2011 using a blue corrugated plastic sign board (image below). We determined that the light color blue with black lines using the corrugated signboard was the most attractive color because it contrasted well with the black lines

We found that American Pantone P 115-5C was a color that was about the same shade of blue as the light blue corrugated plastic signboard that worked best for attracting flies. Around 2017, my company Florida Insect Control Group LLC (assignee of the subject patent application) ordered some flat plastic Pantone P 115-5C traps to be manufactured in China. The prototype that we received from China was a dark blue. We found out by testing the dark blue prototypes in lab cages with flies that the Chinese darker blue color did not work well in attracting flies. We discovered that the Pantone colors in China were different from the American Pantone palette. Since then, we have settled on the American Pantone P 115-5C light blue with black lines as the best color for fly attraction.

In 2018, sticky glue was placed on the American Pantone 115-5C colored boards to attract and trap flies.

During our research, we manufactured cards having a Pantone 115-5C blue color, with black lines printed on one side of the cards, with a separate layer of sticky transparent glue layer applied over the Pantone 115-5C blue color, with black lines.

The use of American Pantone P 115-5C blue with black lines was first disclosed to the U.S. Patent Office in the subject patent application filed Jul. 24, 2025. The invention will also work with a separate Pantone 115-5C blue glue layer applied over a base layer being white with the black line pattern on a lighter surface such as a white surface. The black line pattern being visible through the blue glue overlayer. The base layer can be a material, such as but not limited to card stock, a cardboard sheet layer, paper sheet layer, plastic sheet layer, cardboard stock, and the like.

On Dec. 22, 2025, in a protected courtyard in Gainesville, Florida, Dr. Koehler performed two tests of our invention during noon and 3 pm EST. The temperatures at the time for the two tests were between approximately 65 and approximately 73 degrees F., where these temperatures were high enough temperatures so that the flies would be active. The two tests each covered our manufactured Pantone 115-5C blue surface cards each with multiple black lines on the cards completely covered with a layer of sticky transparent glue on the surface of the Pantone 115-5C blue surface. These manufactured cards by us were tested against the Leonard product, identified as Leonard 5C dark blue) with black lines on cards with a sticky surface, as follows:

The objective of this testing was to determine fly attraction to two colors of blue (Pantone P 115-5C vs Leonard 5C dark blue) with black lines.

### Materials and Methods

Insects—The insects used in this test were house flies, Musca domestica. About 300 fly pupae were supplied by USDA ARS. The fly pupae were allowed to emerge into a fly cage and used within 3 days of emergence.

Pantone blue sticky card—The card was cut to a dimension of 5 inches (12.7 cm) by 8 (20.3 cm) inches. The card had multiple black lines 1 cm apart across the entire card. The lines were 3/16 inches (3.76 mm) wide. Except for the lines, the entire card was colored Pantone P 115-5C blue and covered completely with a sticky glue to catch flies.

Leonard insect sticky card—The card was cut to a dimension of 5 inches (12.7 cm) by 8 inches (20.3 cm). The card had a grid of 0.75 mm wide lines spaced 10 mm apart. The grid allowed captured insects to be easily counted. The entire card was a dark blue color and covered completely with a sticky glue to capture insects that land on the surface.

Bioassay—Sticky cards (Pantone and Leonard were placed on the bottom of a fly cage (1 ft [30 cm] by 1 ft [30 cm] by 2 ft [60 cm]). There was only room for the two tested cards to be place on the bottom of the cage. Flies were released to the cage and after about 5 minutes when the flies had calmed down, the paper covering the glue was removed from each card.

Test #1—About 100 flies were released into the test cage, allowed to calm down, and then the glue was uncovered on both the Pantone and the Leonard sticky cards. After 5 min of normal fly activity, the number of flies captured on each card was counted.

Test #2—About 50 flies were released into the test cage, allowed to calm down, and then the glue was uncovered on both the Pantone and the Leonard sticky cards. After 5 min of normal fly activity, the number of flies captured on each card was counted.

### Results

For both test #1 and #2, the number of flies captured on the Pantone P 115-5C colored card far exceeded the number of flies captured on the Leonard dark blue card (See Table 1). In test #1 the Pantone card caught 3 times more flies and in test #2 the Pantone card caught 9 times more flies than the Leonard dark blue card. FIG. 1 demonstrates the setup of the test cage and the number of flies on both the Pantone blue and the Leonard blue card.

TABLE 1
Number of Flies Capture on Sticky Cards.

| | Color | Flies | Time from | | Flies |
|---|---|---|---|---|---|
| Test | of Card | Released | Release | | Captured |
| 1 | Pantone | 100 | 5 | min. | 33 |
| 1 | Leonard dark | 10 | 5 | min. | 11 |
| | Blue | | | | |
| 2 | Pantone | 50 | 5 | min | 9 |
| 2 | Leonard Dark | | 5 | min | 1 |
| | Blue | | | | |

Our tests on Dec. 22, 2025 under normal temperature conditions between 65 and 73 degrees F. in Gainesville, Florida, provides direct incontrovertible evidence of our claimed use of Pantone 115-5C light blue color with black lines trapped three times and nine times as many flies as the Leonard Dark blue color with black lines.

Although the preferred embodiments describe fixed surfaces formed with blue sticky surfaces having a color of Pantone 115-5C blue color, over black line patterns, the invention can be practiced by a user with a container of blue liquid glue having a having a color of Pantone 115-5C blue color that can be applied by the user to a surface having black line patterns that bleed through the blue layer. A container can be used to store the blue liquid glue having a color of Pantone 115-5C blue color, where the glue remains in a sticky state after it is applied to a surface.

The container and applier can be similar to the containers, shown and described in U.S. Pat. No. 5,873,669 to Poore et al. and U.S. Pat. No. 6,729,788 to Bouveresse, which are incorporated by reference in their entirety. The container can be part of a kit for the user to apply the sticky blue glue to surfaces on pages of a calendar and the like, in order to form another version of the calendar trap.

The kit of the container of the blue glue having a color of Pantone 115-5C blue color that remains in a sticky state, can be used with calendar images on pages, sheets, and the like. As previously described, on each page/sheet, can be individual dates, and/or individual days of the week, and/or a single week, a single month, a plurality of months, an entire year, and the like. The individual sheets/pages can be covered with separate peel and stick layers, and/or be packaged without separate peel and stick layers, similar to pads of sticky notes, and the like.

Types of calendars pads and displays that can use the overlying blue glue that remains in a sticky state, can include calendars, such as those shown and described in U.S. Pat. No. 4,024,656 to Farnsworth; U.S. Pat. No. 4,250,639 to Tarrant; U.S. Pat. No. 4,342,167 to Stanard; U.S. Pat. No. 5,123,191 to Kim; and U.S. Pat. No. 5,426,876 to Jagoe et al., which are each incorporated by reference in their entirety. Additional calendar pads and displays that can use the overlying blue glue that remains in a sticky state, can include calendars, such as those shown and described in U.S. Published Patent Applications: 2005/0012322 to Clilvered and 2012/0175865 to Meyer et al., which are each incorporated by reference in their entirety. Transparent sheet layers can be used as a peel and stick layer to cover each of the calendar pages.

The pantone 115-5C blue color with sticky surface can be placed on both sides of sheet. Peel and stick cover sheets can be initially applied to both the front and rear sides of each sheet. One peel and sheet cover can be removed to expose the sticky surface for use to trap flies. When the exposed side traps collect a sufficient of flies, the peel and stick cover on the opposite side can be removed, and used to cover over the original sticky exposed surface having captured flies, so that the opposite side with sticky surface can be used to trap flies. Novel features of the invention include: sticky fly trap that does not use nor require any toxicants, which are dangerous and unsafe to anyone that handles the live fly trapping device. a sticky fly trap that does not require approval from government agencies, such as the Environmental Protection Agency to be marketed in the United States. This approval, called pesticide registration, takes years to get approval, and involves listing of the manufacturing locations, the fly trap uses dyes having one color of Pantone 115-5C blue, the fly trap is limited to a mixture of dyes that reflect wavelengths of approximately 460 to approximately 490 nm that results in a sky-blue color, the pantone 115-5C blue can be manufactured on fly trap sheet with a transparent clear glue layer, the pantone 115-5C blue can be a layer of sticky glue overlaying a noncolor surface of a base layer, the pantone 115-5C blue glue remains sticky during use. The transparent clear glue layer remains sticky during use, the pantone 115-5C blue can be substantially over one side of a fly trap, the pantone 115-5C blue can be substantially over both sides of a fly trap, the blue color coverage is not limited to target sizes of an insect, such as a fly, the fly trap has been tested to capture between 3 to 9 times as many flies as the main prior art cited by the Patent Office, the sticky trap uses black lines having width between approximately 1 mm and 1 inch, the sticky trap is for use during day time hours between sunrise and sunset, the sticky trap is inexpensively priced up to approximately $10 per package of a fly trap with multiple sheets, which is less than one fifth the cost of the main prior art reference of $59 for Leonard, the fly trap requires flat surface planar sheets, each sheet selected from the group consisting of cardboard sheet, card stock, paper sheet, and plastic sheet. No electric power supply, no use of UV (ultra violet), no afterglow material, no light sources, such as LEDs (Light emitting diodes) are used.

Device able to overlay and be substantially flush with wall, lay on and be substantially flush to table surface, and not extend outward from the wall and table surface.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

The term “approximately” is similar to the term “about” and can be +/−10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A rectangular shaped fly trap device for trapping live flies without toxicants for use during day time hours between sunrise and sunset, consisting of:
a plurality of single sheets stacked together having a rectangular shape configuration, each sheet selected from the group consisting of a cardboard sheet, card stock, a paper sheet, and a plastic sheet;
each of the single sheets having a front side and a rear side,
at least one side of each of the single sheets consisting of black line patterns on a black grid over a noncolor background, the black line patterns include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes;
at least one layer of blue glue, the at least one layer of the blue glue overlaying the at least one side of each sheet forming a blue sticky surface, and the black line patterns are visible through the layer of blue glue, wherein each sheet with the blue sticky surface and black line pattern is exposed for a selected period of time, and then discarded, wherein the layer of blue glue is formed from glue consisting of a mixture of dyes that reflect wavelengths of approximately 460 to approximately 490 nm that results in a sky-blue color, the layer of blue glue is selected from the group consisting of blue liquid glue, blue glue from a blue stick of glue, glue with blue glitter, and non-drying photo mount glue, wherein the blue glue maintains a sticky state after being applied; and
at least one peel and stick cover sheet, the at least one peel and stick cover sheet overlaying the at least one side of each sheet, wherein removing the peel and stick cover sheet exposes the blue sticky surface, wherein each sheet with the sticky surface and black line pattern is exposed for a selected period of time, and then discarded, wherein the fly trap device traps and collects the live flies without using ultra violet light, LEDs (light emitting diodes), afterglow material and electrical power.

2. The rectangular shaped fly trap device of claim 1, wherein both the front side and the rear side consists of the black line patterns on the grid, and the at least one layer of the blue glue, and the at least one peel and stick cover sheet.

3. The rectangular shaped fly trap device of claim 1, wherein the mixture of dyes consists of dyes having the color of Pantone 115-5C blue color.

4. A rectangular shaped fly trap device for trapping live flies without toxicants, for use during day time hours between sunrise and sunset, consisting of:
a plurality of single sheets stacked together having a rectangular shape configuration, each sheet selected from the group consisting of a cardboard sheet, card stock, a paper sheet, and a plastic sheet; each of the single sheets having a front side and a rear side;
each of the single sheets having a front side and a rear side,
at least one side of each of the single sheets solely consisting of
a layer of blue consisting of a mixture of dyes that reflect wavelengths of approximately 460 to approximately 490 nm that results in a sky-blue color;
black line patterns which include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes;
a layer of transparent glue overlaying the at least one side of each sheet forming a sticky surface, wherein the black line patterns and the blue layer are visible; and
at least one peel and stick cover sheet overlaying the at least one side of each sheet, wherein removing the peel and stick cover sheet exposes the blue sticky surface, wherein each sheet with the sticky surface and black line pattern is exposed for a selected period of time, and then discarded, wherein the fly trap device traps and collects the live flies without using ultra violet light, LEDs (light emitting diodes), afterglow material and electrical power.

5. The rectangular shaped fly trap device of claim 4, wherein both the front side and the rear side consists of the black line patterns, the blue layer, the transparent glue layer, and the at least one peel and stick cover sheet.

6. The rectangular shaped fly trap device of claim 4, wherein the mixture of dyes consists of dyes having the color of Pantone 115-5C blue color.

7. A rectangular shaped fly trap device for trapping live flies without toxicants limited to using one color of Pantone 115-5C blue color, and no other colors, for use during day time hours between sunrise and sunset, comprising:
a plurality of single sheets stacked together having a rectangular shape configuration, each sheet selected from the group consisting of a cardboard sheet, card stock, a paper sheet, and a plastic sheet;
each of the single sheets solely consisting of:
black line patterns on a black grid over a noncolor background, the black line patterns include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes; and
a layer of blue glue overlaying each sheet forming a blue sticky surface on each sheet, and the black line patterns are visible through the layer of blue glue, wherein each sheet with the sticky surface and black line pattern is exposed for a selected period of time, and then discarded, wherein the layer of blue glue is formed from glue consisting of a mixture of dyes that reflect wavelengths of approximately 460 to approximately 490 nm that results in a sky-blue color, the layer of blue glue is selected from the group consisting of blue liquid glue, blue glue from a blue stick of glue, glue with blue glitter, and non-drying photo mount glue, wherein the blue glue maintains a sticky state after being applied; and
a peel and stick cover sheet overlaying each sheet, wherein removing the peel and stick cover sheet exposes the blue sticky surface, wherein each sheet with the sticky surface and black line pattern is exposed for a selected period of time, and then discarded, wherein the fly trap device is limited to using only one color, wherein the fly trap device traps and collects the live flies without using ultra violet light, LEDs (light emitting diodes), afterglow material and electrical power, and the fly trap device is sold for up to approximately ten dollars.

8. The rectangular shaped fly trap device of claim 7, wherein the mixture of dyes consists of dyes having the color of Pantone 115-5C blue color.

9. The rectangular shaped fly trap device of claim 8, where the layer of blue glue overlays a front side and a rear side of each sheet, and wherein peel and stick cover sheet overlays the front side and the rear side of each sheet.

10. A rectangular shaped fly trap device for trapping live flies without toxicants limited to using one color of Pantone 115-5C blue color, and no other colors, for use during day time hours between sunrise and sunset, comprising:
a plurality of single sheets stacked together having a rectangular shape configuration, each sheet selected from the group consisting of a cardboard sheet, card stock, a paper sheet, and a plastic sheet;
each of the single sheets solely consisting of:
a layer of blue consisting of a mixture of dyes that reflect wavelengths of approximately 460 to approximately 490 nm that results in a sky-blue color;
black line patterns on a black grid, the black line patterns include individual black lines, each black line between approximately 1 mm and approximately one inch which are wide enough for live flies into believing the black lines are crevices and cracks to hide from in order to avoid desiccation, wherein the black line patterns include black geometrical shapes selected from the group consisting of different size rectangle crack shapes, parallelogram crack shapes, curve and crescent crack shapes;
a layer of transparent glue overlaying each sheet forming a sticky surface on the front side of each sheet, wherein the black line patterns and the blue layer are visible; and
a peel and stick cover sheet overlaying each sheet, wherein removing the peel and stick cover sheet exposes the blue sticky surface, wherein each sheet with the sticky surface and black line pattern is exposed for a selected period of time, and then discarded, wherein the fly trap device is limited to using only one color, wherein the fly trap device traps and collects the live flies without using ultra violet light, LEDs (light emitting diodes), afterglow material and electrical power, and the fly trap device is sold for up to approximately ten dollars.

11. The rectangular shaped fly trap device of claim 10, wherein the mixture of dyes consists of dyes having the color of Pantone 115-5C blue color.

12. The rectangular shaped fly trap device of claim 11, where the layer of blue glue overlays a front side and a rear side of each sheet, and wherein peel and stick cover sheet overlays the front side and the rear side of each sheet.
